(19) United States
(12) Patent Application Publication
(10) Pub. No.: US 2026/0310206 A1
(43) Pub. Date: Oct. 8, 2026

(54) METHOD FOR GENERATING SPACE MAP INCLUDING ACTUAL IMAGE BY USING IMAGE OBTAINED BY PHOTOGRAPHING SPACE, AND ELECTRONIC DEVICE FOR PERFORMING SAME

(71) Applicant: SAMSUNG ELECTRONICS CO., LTD., Suwon-si (KR)

(72) Inventors: Dongnam BYUN, Suwon-si (KR); Dongchan KIM, Suwon-si (KR); Jinyoung HWANG, Suwon-si (KR); Kiwoong PARK, Suwon-si (KR)

(73) Assignee: SAMSUNG ELECTRONICS CO., LTD., Suwon-si (KR)

(21) Appl. No.: 19/683,105

(22) Filed: May 20, 2026

Related U.S. Application Data
(63) Continuation of application No. PCT/KR2024/015112, filed on Oct. 4, 2024.

(30) Foreign Application Priority Data
Nov. 20, 2023 (KR) 10-2023-0161453

(51) Int. Cl. G05D 1/246; G05D 109/10

(52) U.S. Cl. CPC G05D 1/2465; G05D 2109/14

(57) ABSTRACT

This method for generating a space map may include obtaining an initial map of a target space; obtaining a captured image of at least one area of interest in the target space; registering, based on depth information included in the captured image, an actual image to the initial map, the actual image being obtained from the captured image; determining a generation required area for which image generation is required in the initial map to which the actual image is registered; and generating, by using a generative model, an actual map by generating an image for the generation required area.

### CROSS-REFERENCE TO RELATED APPLICATIONS

This application is a continuation of International Application No. PCT/KR2024/015112, filed on Oct. 4, 2024, which is based on and claims priority to Korean Patent Application No. 10-2023-0161453, filed on Nov. 20, 2023, in the Ministry of Intellectual Property, Republic of Korea, the disclosures of which are incorporated by reference herein their entireties.

### BACKGROUND

### 1. Field

The present disclosure relates to a method of generating a spatial map, and more particularly, to a method of generating a spatial map including an actual image by using an image obtained by capturing a space.

### 2. Description of Related Art

An electronic device such as a robot cleaner may scan a space by using a built-in light detection and ranging (LiDAR) sensor while moving through the space, and generate a map (spatial map) for the space based on scan data.

However, when the spatial map is generated by using only data (LiDAR scan data) obtained by scanning the space by using the LiDAR sensor, the generated spatial map may be different from a structure of a realistic space. This is because various objects (e.g., furniture, home appliances, etc.) may exist in the space, and the electronic device may not determine whether a point where a signal (light) emitted from the LiDAR sensor is reflected is a wall surface of the space or an object existing in the space. The electronic device may generate the spatial map by recognizing a point where an object actually exists as a wall surface of the space, and thus, a boundary of the spatial map may be different from the realistic space.

In addition, although the spatial map generated by using the LiDAR scan data represents an overall structure of the space and segmentation of areas included in the space, there is a limitation in that the spatial map fails to provide a sense of realism to a user who views the space due to a large difference from the actual appearance of the space.

### SUMMARY

According to an aspect of the disclosure, there is provided a method including: obtaining an initial map of a target space; obtaining a captured image of at least one area of interest in the target space; registering, based on depth information included in the captured image, an actual image to the initial map, the actual image being obtained from the captured image; determining a generation required area for which image generation is required in the initial map to which the actual image is registered; and generating, by using a generative model, an actual map by generating an image for the generation required area.

According to an aspect of the disclosure, there is provided an electronic device for generating a spatial map, the electronic device including: memory storing instructions; and at least one processor, wherein the instructions, when executed by the at least one processor individually or collectively, may cause the electronic device to: obtain an initial map for a target space, obtain a captured image of at least one area of interest in the target space, register, based on depth information included in the captured image, an actual image to the initial map, the actual image being obtained from the captured image, determine a generation required area for which image generation is required in the initial map to which the actual image is registered, and generate, by using a generative model, an actual map by generating an image for the generation required area.

According to an aspect of the disclosure, there is provided a non-transitory computer-readable recording medium having recorded thereon a program including instructions that, when executed by at least one processor of an electronic device, may cause the electronic device to perform a method including: obtaining an initial map of a target space; obtaining a captured image of at least one area of interest in the target space; based on depth information included in the captured image, registering an actual image to the initial map, the actual image being obtained from the captured image; determining a generation required area for which image generation is required in the initial map to which the actual image is registered; and generating, by using a generative model, an actual map by generating an image for the generation required area.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a system for generating a spatial map according to an embodiment of the present disclosure;

FIG. 2 is a diagram illustrating an initial map generated based on LiDAR scan data and an actual map generated by using a captured image according to an embodiment of the present disclosure;

FIG. 3 is a diagram for describing a configuration of a server included in a system for generating a spatial map according to an embodiment of the present disclosure;

FIG. 4 is a diagram for describing a configuration of a robot cleaner included in a system for generating a spatial map according to an embodiment of the present disclosure;

FIG. 5 is a diagram illustrating user interface (UI) screens displayed on a mobile terminal in a process of generating a spatial map according to an embodiment of the present disclosure;

FIG. 6 is a diagram for describing a method by which an electronic device (server) recommends an area of interest to be captured, a capturing position, and a capturing direction to a user according to an embodiment of the present disclosure;

FIG. 7 is a diagram for describing a method by which an electronic device (server) generates an estimated map representing a layout of an area of interest from a captured image of the area of interest according to an embodiment of the present disclosure;

FIG. 8 is a diagram for describing a method by which an electronic device (server) matches an estimated map to an initial map based on a border extracted from the estimated map according to an embodiment of the present disclosure;

FIG. 9 is a diagram for describing a process in which an electronic device (server) generates an actual map from an initial map to which an actual image is registered according to an embodiment of the present disclosure; and

FIGS. 10, 11, 12, 13, 14, 15, 16, 17, and 18 are flowcharts for describing a method of generating a spatial map according to embodiments of the present disclosure.

### DETAILED DESCRIPTION

In the following description of the present disclosure, descriptions of techniques that are well known in the art and not directly related to the present disclosure are omitted. This is to clearly convey the gist of the present disclosure by omitting an unnecessary description. The terms used herein are those defined in consideration of functions in the present disclosure, and may vary according to the intention of users or operators, precedents, etc. Hence, the terms used herein should be defined based on the meaning of the terms together with the descriptions throughout the specification.

For the same reason, some elements in the accompanying drawings are exaggerated, omitted, or schematically illustrated. Also, the size of each element may not substantially reflect its actual size. In each drawing, the same or corresponding element is denoted by the same reference numeral.

The advantages and features of the present disclosure, and methods of achieving the same, will become apparent with reference to embodiments of the present disclosure described below in detail in conjunction with the accompanying drawings. The present disclosure may, however, be embodied in many different forms and should not be construed as limited to embodiments of the present disclosure set forth herein. These embodiments of the present disclosure are provided so that this disclosure will be thorough and complete, and will fully convey the scope of the present disclosure to one of ordinary skill in the art. An embodiment of the present disclosure may be defined according to the claims. In the specification, the same reference numerals denote the same elements. Also, while describing the present disclosure, detailed descriptions of related well-known functions or configurations that may blur the points of the present disclosure are omitted. The terms used herein are those defined in consideration of functions in the present disclosure, and may vary according to the intention of users or operators, precedents, etc. Hence, the terms used herein should be defined based on the meaning of the terms together with the descriptions throughout the specification.

It will be understood that each block of flowchart illustrations and combinations of blocks in the flowchart illustrations may be implemented by computer program instructions. These computer program instructions may be loaded into a processor of a general-purpose computer, special purpose computer, or other programmable data processing apparatus, and the instructions, which are executed via the processor of the computer or other programmable data processing apparatus may generate means for implementing the functions specified in the flowchart block(s). These computer program instructions may also be stored in a computer usable or computer-readable memory that may direct a computer or other programmable data processing apparatus to function in a particular manner, and the instructions stored in the computer usable or computer-readable memory may produce an article of manufacture including instruction means that implement the functions specified in the flowchart block(s). The computer program instructions may also be loaded onto a computer or other programmable data processing apparatus.

Also, each block of the flowchart illustrations may represent a module, segment, or portion of code, which includes one or more executable instructions for implementing the specified logical function(s). It should also be noted that in an embodiment, the functions noted in the blocks may occur out of the order shown. For example, two blocks shown in succession may in fact be executed substantially concurrently or the blocks may sometimes be executed in the reverse order, depending upon the functionality involved.

The term “ . . . unit” used in the present embodiment of the present disclosure refers to a software or hardware component, such as a field-programmable gate array (FPGA) or an application-specific integrated circuit (ASIC), which performs certain tasks. However, “ . . . unit” does not mean to be limited to software or hardware. A “ . . . unit” may be configured to be in an addressable storage medium or may be configured to operate one or more processors. In an embodiment of the present disclosure, “ . . . unit” may include components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in components and “ . . . units“may be combined into fewer components and” . . . units” or further separated into additional components and “ . . . units”. Also, a “ . . . unit” in an embodiment may include one or more processors.

Hereinafter, the meanings of terms used in the present disclosure will be described.

“Spatial map” may refer to a map representing a structure or shape of a certain space. According to an embodiment of the present disclosure, a spatial map representing a structure of a house in which a user resides may be generated by using an electronic device such as a robot cleaner or a server. The “spatial map” may be in a form in which various information (e.g., home appliances or furniture disposed in the space) is added to a general floor plan representing the structure of the house or the like. Instead of “spatial map”, terms such as “floor plan” or “spatial layout” may be used.

“LiDAR scan data” may refer to data obtained by scanning a target space by using a LiDAR sensor provided in the electronic device. According to an embodiment of the present disclosure, the electronic device may obtain LiDAR scan data including depth values (distances from the LiDAR sensor to a plurality of points) of the plurality of points located at a pre-determined specific height by using the LiDAR sensor. According to an embodiment of the present disclosure, the electronic device may obtain ToF scan data including depth values of a plurality of points located at a specific height by using a ToF sensor instead of the LiDAR sensor, and may perform embodiments of the present disclosure by using the ToF scan data instead of the LiDAR scan data. Alternatively, according to an embodiment of the present disclosure, the electronic device may obtain stereo vision scan data including depth values of a plurality of points located at a specific height by using stereo vision technology using two cameras instead of the LiDAR sensor, and may perform embodiments of the present disclosure by using the stereo vision scan data instead of the LiDAR scan data. Instead of “LiDAR scan data”, terms such as “1D scan data”, “LiDAR data”, “depth scan data”, or “scan data” may be used.

“Initial map” may refer to a spatial map generated based on the LiDAR scan data, and “actual map” may refer to a spatial map including an actual image. The actual map may include an actual image representing a shape and a color of a realistic space and shapes and colors of objects (e.g., home appliances, furniture, etc.) disposed in the space. According to an embodiment of the present disclosure, the electronic device may generate the actual map by attaching an actual image obtained from a captured image to the initial map and generating an image by using a generative model in an empty area. Instead of “initial map”, terms such as “initial space map”, “LiDAR map”, and “LiDAR spatial map” may be used. In addition, instead of “actual map”, terms such as “actual image map”, “actual floor plan”, “actual spatial map”, “user interface (UI) space map”, or “realistic map” may be used.

“Area of interest” may refer to an area that should be captured in order to convert the initial map into the actual map. The electronic device according to an embodiment of the present disclosure may generate the actual map from the initial map by using an image obtained by capturing areas of interest. Also, the electronic device according to an embodiment of the present disclosure may recommend an area of interest to the user. Instead of “area of interest”, terms such as “designated area” or “recommended area” may be used.

“Captured image” may refer to an image obtained by capturing the area of interest. According to an embodiment of the present disclosure, the captured image may be an RGB image, and may be converted into a depth image through depth estimation as described in embodiments of the present disclosure.

“Actual image” may refer to an image representing a realistic appearance of a space. The actual image may represent a shape and color of a realistic space and shapes and colors of objects (e.g., home appliances, furniture, etc.) disposed in the space. According to an embodiment of the present disclosure, the electronic device may obtain an actual image (of a viewpoint different from that of the captured image) from the captured image. Instead of “actual image”, terms such as “realistic image” may be used.

“Depth image” may refer to an image including depth information for a specific space. Each of a plurality of points included in the depth image may have a corresponding depth value. As described above, the depth image may be obtained by performing depth estimation on the captured image. Instead of “depth image”, terms such as “depth map” or “depth estimation image” may be used.

“Depth value” may refer to a distance from a position (e.g., a position of the electronic device that performs capturing or scanning) that is a reference for measurement to a specific point in the space.

“Registration” may refer to a processing technique for representing different images in one coordinate system. In embodiments of the present disclosure, “registering an actual image to an initial map” may refer to an operation of estimating a position corresponding to a captured image in the initial map and attaching an actual image obtained from the captured image to the estimated position. Instead of “registration”, terms such as “matching” or “attaching” may be used.

Hereinafter, embodiments of the present disclosure will be described in detail with reference to the drawings.

Embodiments of the present disclosure relate to a method of generating an actual map representing an appearance of a realistic space from an initial map generated based on data obtained by scanning the space through a LiDAR sensor by using images obtained by capturing the space, and an electronic device for performing the method.

The electronic device for performing the embodiments described in the present disclosure may be implemented in various forms. According to an embodiment, the electronic device may be a robot-type mobile device such as a robot cleaner, or may be a server connected to the robot-type mobile device. Roles or operations performed by electronic devices (robot cleaner, server, mobile terminal, and the like) included in a system according to embodiments of the present disclosure will be described in detail below with reference to the drawings.

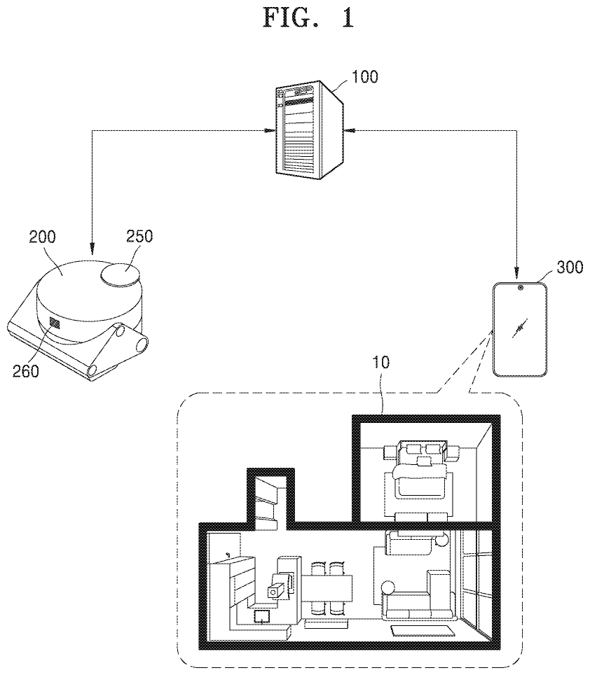

FIG. 1 is a diagram illustrating a system for generating a spatial map according to an embodiment of the present disclosure. Referring to FIG. 1, a system for generating a spatial map according to an embodiment of the present disclosure may include a server 100, a robot cleaner 200, and a mobile terminal 300.

As described above, the spatial map according to embodiments of the present disclosure may include an initial map and an actual map, and hereinafter, the initial map and the actual map will be described separately.

The system according to an embodiment of the present disclosure may generate the initial map by using LiDAR scan data (1D scan data) obtained by the robot cleaner 200, and may generate the actual map from the initial map by using a captured image captured by using the mobile terminal 300.

An operation of generating the initial map and generating the actual map may be performed by any one of devices (the server 100, the robot cleaner 200, and the mobile terminal 300) included in the system, or may be performed by a combination of two or more of the devices. For example, when the robot cleaner 200 transmits the LiDAR scan data to the server 100 and the mobile terminal 300 transmits the captured image to the server 100, the server 100 may generate both the initial map and the actual map. Alternatively, for example, when the robot cleaner 200 generates the initial map based on the LiDAR scan data and transmits the generated initial map to the server 100, and the mobile terminal 300 transmits the captured image to the server 100, the server 100 may generate the actual map from the received initial map.

In the present disclosure, embodiments will be described assuming that the server 100 generates both the initial map and the actual map. Although the server 100 performs all processes of generating an actual map 10 in embodiments of the present disclosure, some or all of the processes may be performed by another device (the robot cleaner 200 or the mobile terminal 300).

The robot cleaner 200 may obtain the LiDAR scan data by measuring depths of a plurality of points located at a specific height of a target space by using a LiDAR sensor 250. According to an embodiment of the present disclosure, another type of electronic device (e.g., a robot-type mobile device—a device for performing various operations while moving automatically or according to a user's command) other than the robot cleaner 200 may be used. For example, an electronic device such as a butler robot or a pet robot may be used.

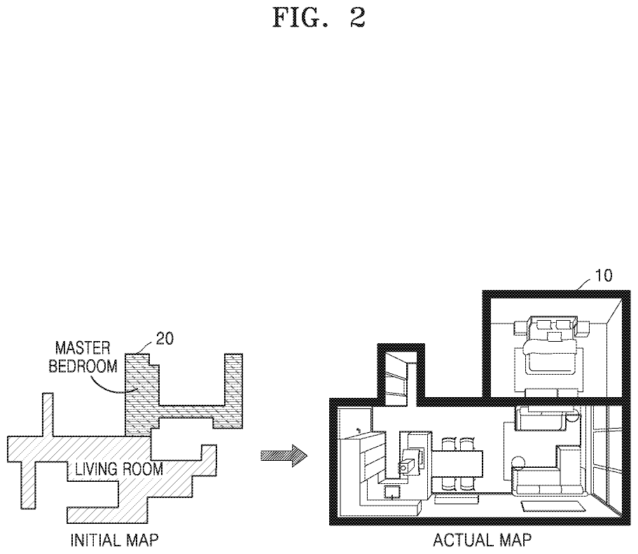

When the LiDAR scan data obtained by the robot cleaner 200 is transmitted to the server 100, the server 100 may generate the initial map based on the LiDAR scan data. FIG. 2 illustrates an initial map 20 generated based on LiDAR scan data. Referring to FIG. 2, the initial map 20 represents a layout of a target space seen from a top view, and separately displays a plurality of areas (a living room and a master bedroom).

The initial map 20 represents only a structure of the target space (borders and segmentation of areas), but the actual map 10 represents a realistic appearance of the target space (shapes and colors of the target space and home appliances/furniture disposed in the target space). In addition, when the initial map 20 and the actual map 10 are compared, it is found that a border of the initial map 20 does not accurately reflect the structure of the realistic space.

As such, when the server 100 generates the initial map 20 by using only the LiDAR scan data, distortion of the space may occur. This is because various objects (e.g., furniture, home appliances, etc.) may exist in the space, and the server 100 may not distinguish whether a point where a laser pulse is reflected is a wall surface of the space or an object by using only the LiDAR scan data, and thus may generate the initial map 20 by recognizing the object as the wall surface of the space. In addition, according to an embodiment of the present disclosure, the robot cleaner 200 obtains the LiDAR scan data by performing a LiDAR scan at a low height, and there is a high possibility that an object exists at a height (e.g., a height close to a floor surface) where the LiDAR scan is performed. Accordingly, the initial map 20 generated based only on the LiDAR scan data may be different from a realistic structure (floor plan) of the space.

When the mobile terminal 300 transmits an image obtained by capturing a plurality of areas (areas of interest) in the target space to the server 100, the server 100 may generate the actual map 10 from the initial map 20 by using the received captured image. In this process, the user needs to capture the area of interest by using the mobile terminal 300, and the server 100 may recommend the area of interest, a capturing position, and a capturing direction to the user through the mobile terminal 300. When the server 100 transmits the actual map 10 to the mobile terminal 300, the user may check the actual map 10 through a screen of the mobile terminal 300.

According to an embodiment of the present disclosure, the server 100 may generate the actual map 10 by using images obtained by capturing a plurality of areas (areas of interest) in the target space by the robot cleaner 200. To this end, the server 100 may transmit information on a position of the area of interest, a position and a direction where the robot cleaner 200 should perform capturing, and the like to the robot cleaner 200.

According to an embodiment of the present disclosure, an application for use and control of the robot cleaner 200 may be installed in the mobile terminal 300. The server 100 may guide a process of generating the actual map 10 to the user or may request an operation required to generate the actual map 10 (e.g., capture the area of interest) through the application. When the application is executed, the user may check the actual map 10 through a UI screen displayed on the mobile terminal 300.

Hereinafter, a specific process in which the server 100 generates the actual map 10 from the initial map 20 by using the captured image received from the mobile terminal 300 will be described in detail with reference to the drawings.

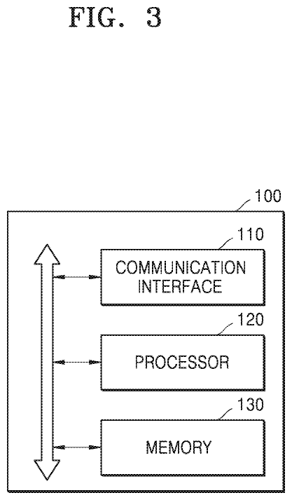

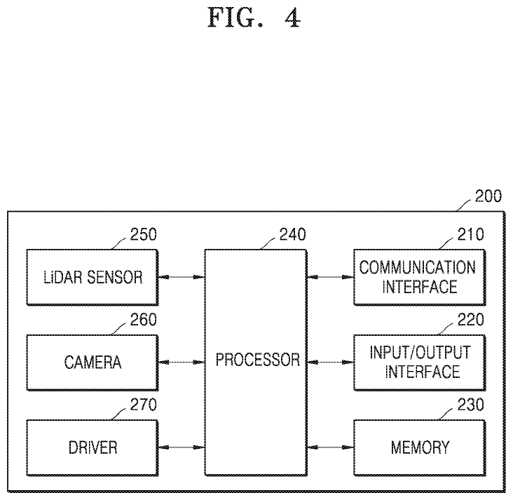

First, components included in the server 100 and the robot cleaner 200 will be described with reference to FIGS. 3 and 4.

FIG. 3 is a diagram for describing a configuration of a server included in a system for generating a spatial map according to an embodiment of the present disclosure. Referring to FIG. 3, the server 100 according to an embodiment of the present disclosure may include a communication interface 110, at least one processor 120 (hereafter referred to as “the processor 120”), and memory 130. However, components of the server 100 are not limited thereto, and the server 100 may include more components or fewer components than the above components. Some or all of the communication interface 110, the processor 120, and the memory 130 may be implemented in the form of one chip. According to an embodiment of the present disclosure, the server 100 may be a home IoT server that controls home IoT devices such as the robot cleaner 200.

The communication interface 110 is configured to transmit and receive a signal (control command, data, etc.) to and from an external device by wire or wirelessly, and may include a communication chipset supporting various communication protocols. The communication interface 110 may receive a signal from the outside and output the signal to the processor 120, or may transmit a signal output from the processor 120 to the outside. The server 100 may communicate with the robot cleaner 200 or the mobile terminal 300 through the communication interface 110.

The processor 120 is configured to control a series of processes such that the server 100 operates according to embodiments described below, and may include one or more processors. In this case, the one or more processors may be a general-purpose processor such as a CPU, an AP, or a digital signal processor (DSP), a graphics-dedicated processor such as a GPU or a vision processing unit (VPU), or an artificial intelligence (AI)-dedicated processor such as an NPU. For example, when the one or more processors are AI-dedicated processors, the AI-dedicated processors may be designed with a hardware structure specialized in processing a specific AI model.

The processor 120 may record data in the memory 130 or read data stored in the memory 130, and in particular, may process data according to a predefined operation rule or an AI model by executing a program stored in the memory 130. Accordingly, the processor 120 may perform operations described in the following embodiments. In the following embodiments, operations described as being performed by the server 100 may be regarded as being performed by the processor 120 unless otherwise specified.

The memory 130 is configured to store various programs or data, and may include a storage medium such as a ROM, a RAM, a hard disk, a CD-ROM, a DVD, or the like, or a combination of storage media. The memory 130 may not exist separately but may be included in the processor 120. The memory 130 may include a volatile memory, a non-volatile memory, or a combination of a volatile memory and a non-volatile memory. A program for performing operations according to embodiments described below may be stored in the memory 130. The memory 130 may provide stored data to the processor 120 according to a request from the processor 120.

The server 100 may receive LiDAR scan data from the robot cleaner 200 through the communication interface 110, and the processor 120 may generate the initial map 20 based on the received LiDAR scan data and then store the initial map 20 in the memory 130. In addition, the server 100 may receive a captured image from the mobile terminal 300 through the communication interface 110, and the processor 120 may generate the actual map 10 from the initial map 20 stored in the memory 130 by using the received captured image and then store the actual map 10 in the memory 130 again. When there is a request from the mobile terminal 300, the server 100 may transmit the actual map 10 stored in the memory 130 to the mobile terminal 300.

FIG. 4 is a diagram for describing a configuration of a robot cleaner included in a system for generating a spatial map according to an embodiment of the present disclosure. Referring to FIG. 4, the robot cleaner 200 according to an embodiment of the present disclosure may include a communication interface 210, an input/output interface 220, a memory 230, a processor 240, a LiDAR sensor 250, a camera 260, and a driver 270. However, components of the robot cleaner 200 are not limited thereto, and the robot cleaner 200 may include more components or fewer components than the above components. Some or all of the communication interface 210, the input/output interface 220, the memory 230, and the processor 240 may be implemented in the form of one chip.

The communication interface 210 is configured to transmit and receive a signal (control command, data, etc.) to and from an external device by wire or wirelessly, and may include a communication chipset supporting various communication protocols. The communication interface 210 may receive a signal from the outside and output the signal to the processor 240, or may transmit a signal output from the processor 240 to the outside. The robot cleaner 200 may communicate with the server 100 through the communication interface 210. According to an embodiment of the present disclosure, the robot cleaner 200 may transmit LiDAR scan data obtained through the LiDAR sensor 250 described later or captured images obtained through the camera 260 to the server 100 or the mobile terminal 300 through the communication interface 210.

The input/output interface 220 may include an input interface (e.g., a touch screen, a hard button, a microphone, etc.) for receiving a control command or information from a user, and an output interface (e.g., a display panel, a speaker, etc.) for displaying an execution result of an operation according to the control of the user or a state of the robot cleaner 200.

The memory 230 is configured to store various programs or data, and may include a storage medium such as a ROM, a RAM, a hard disk, a CD-ROM, a DVD, or the like, or a combination of storage media. The memory 230 may not exist separately but may be included in the processor 240. The memory 230 may include a volatile memory, a non-volatile memory, or a combination of a volatile memory and a non-volatile memory. A program for performing operations according to embodiments described below may be stored in the memory 230. The memory 230 may provide stored data to the processor 240 according to a request from the processor 240.

The processor 240 is configured to control a series of processes such that the robot cleaner 200 operates according to embodiments of the present disclosure described below, and may include one or more processors. In this case, the one or more processors may be a general-purpose processor such as a CPU, an AP, or a digital signal processor (DSP), a graphics-dedicated processor such as a GPU or a vision processing unit (VPU), or an AI-dedicated processor such as an NPU. For example, when the one or more processors are AI-dedicated processors, the AI-dedicated processors may be designed with a hardware structure specialized in processing a specific AI model.

The processor 240 may record data in the memory 230 or read data stored in the memory 230, and in particular, may process data according to a predefined operation rule or an AI model by executing a program stored in the memory 230. Accordingly, the processor 240 may perform operations described in the following embodiments. In the following embodiments, operations described as being performed by the robot cleaner 200 may be regarded as being performed by the processor 240 unless otherwise specified.

The LiDAR sensor 250 is configured to allow the robot cleaner 200 to scan a distance (depth) to a wall surface or an object in a surrounding space. The robot cleaner 200 may measure depths for a plurality of areas included in a target space by using the LiDAR sensor 250, and transmit measured depth values to the server 100 or generate a spatial map (initial map) based on the measured depth values.

The camera 260 is configured to allow the robot cleaner 200 to capture the surrounding space. The robot cleaner 200 may include the camera 260 to recognize an object (e.g., an obstacle) in front. According to an embodiment of the present disclosure, the robot cleaner 200 may transmit an image obtained by capturing an area of interest through the camera 260 to the server 100.

The driver 270 is configured to provide power necessary for the robot cleaner 200 to perform a cleaning operation. The robot cleaner 200 may move in a space due to a driving force provided by the driver 270 and perform a cleaning operation (e.g., suction, etc.). According to an embodiment, the driver 270 may include a motor, a battery, and the like.

Hereinafter, a process in which the server 100 according to an embodiment of the present disclosure generates a spatial map (an initial map and an actual map) will be described in detail.

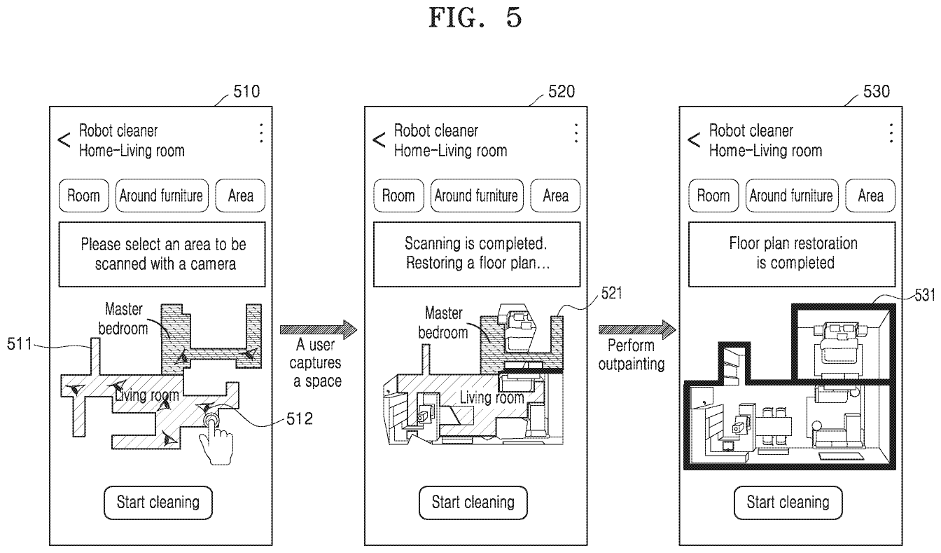

FIG. 5 is a diagram illustrating UI screens displayed on a mobile terminal in a process of generating a spatial map according to an embodiment of the present disclosure. UI screens (e.g., 510, 520, and 530) illustrated in FIG. 5 may be execution screens of an application installed in the mobile terminal 300, and the server 100 may transmit information (e.g., an initial map, an actual map, a capturing position/capturing direction, etc.) required to display the UI screens (e.g., 510, 520, and 530) to the mobile terminal 300.

An initial map 511 generated based on LiDAR scan data is displayed on a first UI screen 510. An icon 512 for recommending a capturing position and a capturing direction may be displayed on the initial map 511 of the first UI screen 510. The icon 512 indicates to capture a space from a position (capturing position) where a vertex of the icon 512 is located toward a direction (capturing direction) in which the icon 512 widens. A message for requesting a user to select an area to be scanned (captured) may also be displayed on the first UI screen 510.

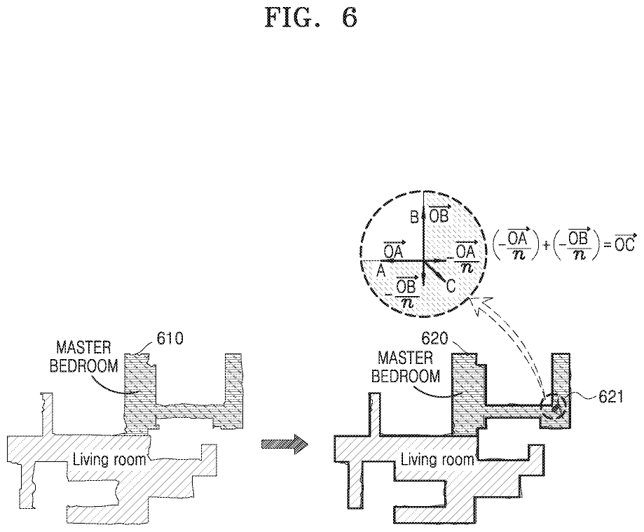

When the user selects the icon 512 and performs capturing by using the mobile terminal 300 according to the capturing position and the capturing direction recommended by the icon 512, the mobile terminal 300 may obtain a captured image of an area of interest recommended by the server 100. A method by which the server 100 recommends the area of interest, the capturing position, and the capturing direction will be described in detail below with reference to FIG. 6. As described above, instead of the user capturing areas of interest by using the mobile terminal 300, the areas of interest may be captured by using the camera 260 provided in the robot cleaner 200 and captured images may be transmitted to the server 100.

When the user captures a target space (area of interest) by using the mobile terminal 300 according to the icons 512 on the initial map 511 displayed on the first UI screen 510, an initial map 521 to which actual images for the areas of interest are attached may be displayed on a second UI screen 520. According to an embodiment of the present disclosure, when the mobile terminal 300 transmits captured images for the areas of interest to the server 100, the server 100 may register actual images obtained from the captured images to the initial map 511, and may transmit a result thereof to the mobile terminal 300. The mobile terminal 300 may display the initial map 521 to which the actual images are registered on the second UI screen 520, and a message indicating that scanning (capturing) for the areas of interest has been completed and a floor plan (actual map) is being restored may also be displayed on the second UI screen 520.

Subsequently, when a certain time elapses, image generation (e.g., outpainting) using a generative model may be performed on the initial map 521 to which the actual images are attached, and an actual map 531 may be displayed on a third UI screen 530. According to an embodiment of the present disclosure, the server 100 may perform outpainting on an area where the actual images are not included in the initial map 521, but is not limited thereto, and the robot cleaner 200 or the mobile terminal 300 may perform the outpainting.

### 1. Method of Recommending an Area of Interest, a Capturing Position, and a Capturing Direction (FIG. 6)

FIG. 6 is a diagram for describing a method by which an electronic device (server) recommends an area of interest to be captured, a capturing position, and a capturing direction to a user according to an embodiment of the present disclosure.

In FIG. 6, a first initial map 610 and a second initial map 620 are illustrated. When the server 100 generates a spatial map based on LiDAR scan data received from the robot cleaner 200, the spatial map is generated in a form such as the first initial map 610. The server 100 may perform contour approximation on the first initial map 610 to determine areas of interest that need to be captured. When the server 100 performs the contour approximation on the first initial map 610, a border organized in a straight line form may be displayed as shown in the second initial map 620.

The server 100 may determine at least one vertex (a position corresponding to the vertex) satisfying a preset condition among a plurality of vertices included in the border of the second initial map 620 as an area of interest. According to an embodiment of the present disclosure, the server 100 may determine a concave vertex among the plurality of vertices included in the border of the second initial map 620 as the area of interest. According to an embodiment of the present disclosure, the server 100 may determine the area of interest by comparing a size of an interior angle of a vertex with a preset reference value, and for example, may determine a vertex whose interior angle is greater than or equal to 180° as the area of interest. The server 100 according to an embodiment of the present disclosure may select a vertex according to various other conditions and determine the selected vertex as the area of interest.

When the area of interest is determined, the server 100 may determine a position (capturing position) and a direction (capturing direction) for capturing the area of interest and may recommend the determined position and direction to the user. How the server 100 sets the capturing position and the capturing direction for an area of interest 621 determined in the second initial map 620 of FIG. 6 will be described in detail below.

Referring to the second initial map 620, it is assumed that a vertex determined as the area of interest 621 is placed at an origin O, and two vertexes adjacent to the vertex placed at the origin O are located at A and B, respectively. The server 100 may obtain a vector \vec{OC} by substituting a vector \vec{OA} from the origin O to A and a vector \vec{OB} from the origin O to B into Equation 1.

$$( - \frac{\vec{OA}}{n} ) + ( - \frac{\vec{OB}}{n} ) = \vec{OC} \qquad [ Equation 1 ]$$

The server 100 may determine a position corresponding to C as the capturing position, and may determine a direction of the vector \vec{CO} as the capturing direction. The server 100 may display an icon on the second initial map 620 according to the determined capturing position and capturing direction.

As described above, the server 100 may determine a vertex selected according to a preset condition among the vertices included in the border of the initial map as the area of interest, and may recommend the capturing position and the capturing direction to the user based on distances from the selected vertex to adjacent vertices.

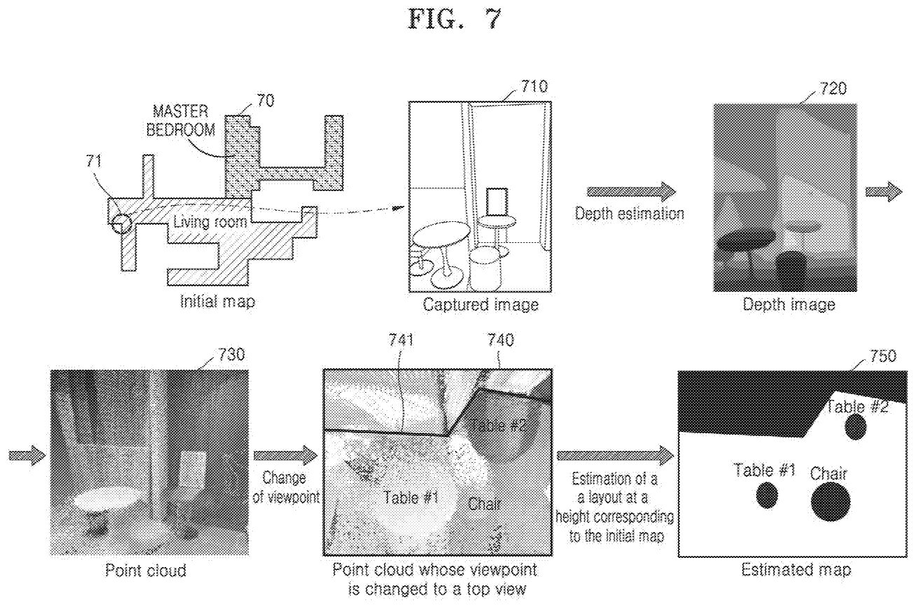

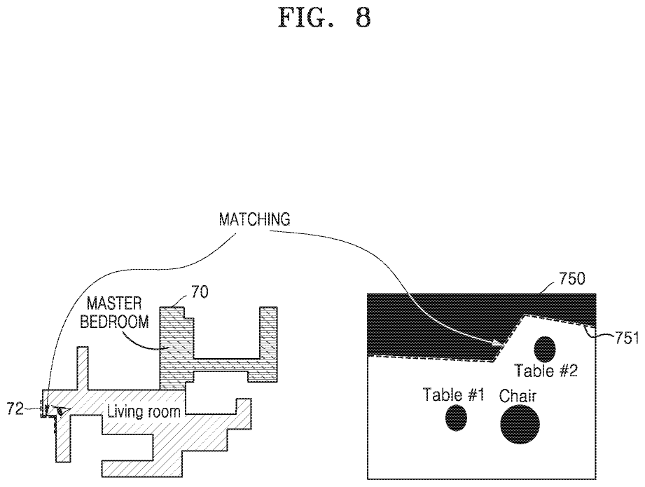

2. Method of Registering an Actual Image Obtained from a Captured Image to an Initial Map (FIGS. 7 and 8)

Because a user captures an area of interest according to a position and a direction recommended by the server 100, the server 100 may roughly know to which position on an initial map a captured image corresponds. However, in order for the server 100 to attach an actual image obtained from the captured image to the initial map, it is necessary to identify an accurate position corresponding to the captured image (or the actual image). According to an embodiment of the present disclosure, the server 100 may register the actual image obtained from the captured image to the initial map, based on depth information included in the captured image.

Hereinafter, a specific process in which the server 100 registers the actual image obtained from the captured image to the initial map will be described in detail with reference to FIGS. 7 and 8.

First, a process of generating an estimated map will be described with reference to FIG. 7. FIG. 7 is a diagram for describing a method by which an electronic device (server) generates an estimated map representing a layout of an area of interest from a captured image of the area of interest according to an embodiment of the present disclosure.

The server 100 may receive a captured image 710 for any one area of interest 71 included in an initial map 70 from the mobile terminal 300. The server 100 may obtain a depth image 720 by performing depth estimation on the captured image 710, and may convert the depth image 720 into a point cloud 730.

Subsequently, the server 100 may change a viewpoint of the point cloud to a top view. A point cloud whose viewpoint is changed to the top view (hereinafter, referred to as a “top-view point cloud”) 740 is illustrated in FIG. 7.

The server 100 may obtain an estimated map 750 for an area corresponding to the captured image 710 based on the top-view point cloud 740. The estimated map 750 may represent a layout at a height corresponding to the initial map 70. In this case, the “height corresponding to the initial map 70” may refer to a height at which 1 D scan data (LiDAR scan data) is collected from a target space to generate the initial map 70. That is, when the initial map 70 is generated based on the LiDAR scan data collected by the robot cleaner 200, a height (scan height) of the LiDAR sensor 250 installed in the robot cleaner 200 may be the height corresponding to the initial map 70.

The server 100 may extract a density of the top-view point cloud 740 at the height corresponding to the initial map 70, and may estimate a layout at the height corresponding to the initial map 70 based on the extracted density. Next, the server 100 may generate the estimated map 750 by representing the estimated layout as a map. The density extracted by the server 100 from the top-view point cloud 740 may correspond to a density on a cross-section at the height corresponding to the initial map 70. In other words, the density extracted by the server 100 from the top-view point cloud 740 may correspond to a density of voxels located at the height corresponding to the initial map 70.

A specific method by which the server 100 estimates the layout at the height corresponding to the initial map 70 based on the density extracted from the top-view point cloud 740 will be described as follows. According to an embodiment of the present disclosure, the server 100 may compare the density extracted from the top-view point cloud 740 with a preset reference value, may binarize the cross-section at the height corresponding to the initial map 70 based on a comparison result, and may estimate the layout based on a binarization result. For example, the server 100 may perform binarization by assigning 1 to voxels whose extracted density is less than the reference value and assigning 0 to voxels whose extracted density is equal to or greater than the reference value, and may estimate the layout based on the binarization result. In this case, the reference value may be set to an appropriate value such that the binarization result may most closely represent a layout of a realistic space.

The server 100 may estimate the layout based on the binarization result and may represent the estimated layout as the estimated map 750. For example, the server 100 may generate the estimated map 750 by displaying voxels to which 1 is assigned in white and voxels to which 0 is assigned in black.

A reason why the server 100 generates the estimated map 750 by estimating the layout at the height corresponding to the initial map 70 is as follows. The server 100 needs to identify a border of the space in order to find an accurate position corresponding to the captured image 710. The server 100 may extract a border 741 (a border between a wall surface and a floor surface) of the space from the top-view point cloud 740, but it is difficult to identify an accurate border in the top view because a part of the border may be hidden by objects. Accordingly, the server 100 estimates the layout at the height at which information (LiDAR scan data) used to generate the initial map 70 is collected, and identifies a border in the estimated layout.

Next, a process of matching the generated estimated map to the initial map will be described with reference to FIG. 8 together. FIG. 8 is a diagram for describing a method by which an electronic device (server) matches an estimated map to an initial map based on a border extracted from the estimated map according to an embodiment of the present disclosure.

Referring to FIGS. 7 and 8, the server 100 may extract a border 751 of a target space from the estimated map 750. For example, the server 100 may extract the border 751 between a wall surface and a floor in the estimated map 750. In addition, the server 100 may extract a border 72 from the area of interest 71 (area of interest corresponding to the estimated map 750) of the initial map 70. The server 100 may identify a position where the estimated map 750 is matched on the initial map 70 by comparing the border 751 extracted from the estimated map 750 with the border 72 extracted from the initial map 70.

Meanwhile, according to an embodiment of the present disclosure, the server 100 may perform slicing (Z-slicing) on the point cloud 730 at certain height intervals from a floor surface, and estimate a position corresponding to the captured image 710 on the initial map 70 based on sliced cross-sections. For example, when the server 100 inputs the cross-sections obtained by slicing the point cloud 730 and the initial map 70 into a pre-trained neural network model, the neural network model may output a result of estimating a position corresponding to the point cloud 730, that is, the position corresponding to the captured image 710. To this end, the neural network model may be trained by using, as training data, cross-sections obtained by slicing point clouds corresponding to a plurality of areas in a space at certain height intervals, and shapes of borders of spatial maps corresponding to the corresponding areas.

When the server 100 identifies the position where the estimated map 750 is matched on the initial map 70, the server 100 may attach an actual image obtained from the captured image 710 to the identified position. A specific method by which the server 100 obtains the actual image from the captured image 710 is as follows.

As described above, the server 100 may obtain the point cloud 730 from the captured image 710 and may change a viewpoint of the point cloud 730 to a top view. The server 100 may obtain the actual image from the top-view point cloud 740.

When the captured image 710 is an RGB image, the captured image 710 may include pixels to which RGB values are assigned. RGB values may be assigned to voxels constituting the point cloud 730 based on the RGB values assigned to the pixels of the captured image 710. The server 100 may generate the actual image based on RGB values assigned to voxels of the top-view point cloud 740.

Because the top-view point cloud 740 has a different viewpoint from the captured image 710, there may be no RGB values assigned to some voxels included in the top-view point cloud 740. According to an embodiment of the present disclosure, the server 100 may assign RGB values to voxels to which RGB values are not assigned by using interpolation. Alternatively, the server 100 may assign arbitrary RGB values to the voxels to which RGB values are not assigned, or may not assign any values.

As such, RGB values that do not accurately reflect an appearance of a realistic space may be assigned to some pixels included in the actual image obtained from the captured image 710 due to a lack of information, but because the actual image is reduced and attached to the initial map 70, the user may not recognize such an error.

The actual image obtained according to the above-described method may correspond to an image obtained by changing the viewpoint of the captured image 710 to the top view.

The server 100 may obtain captured images corresponding to a plurality of areas of interest included in the target space, and may register all actual images obtained from the captured images to the initial map. When the actual images corresponding to the areas of interest are registered to the initial map, preparation for image generation using a generative model is completed.

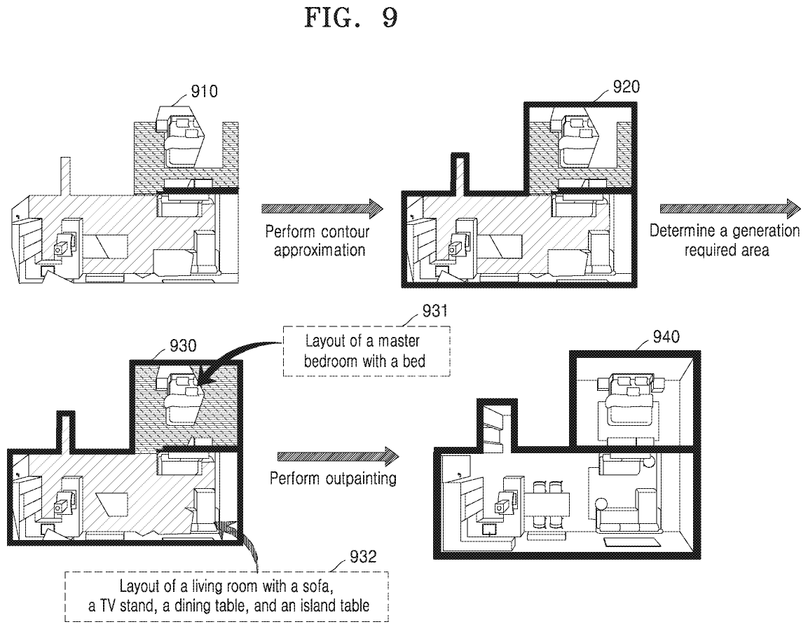

### 3. Method of Generating an Image by Determining a Generation Required Area and Generating a Prompt Based on Metadata (FIG. 9)

When the actual images are registered to the initial map, the server 100 may determine a generation required area where image generation is required, and may generate an image (e.g., perform outpainting) for the generation required area by using a generative model.

FIG. 9 is a diagram for describing a process in which an electronic device (server) generates an actual map from an initial map to which an actual image is registered according to an embodiment of the present disclosure.

A first spatial map 910 illustrated in FIG. 9 is an initial map to which actual images are registered. Areas indicated by hatching in the first spatial map 910 correspond to areas (generation required areas) where image generation is required. However, as described above, the first spatial map 910 is highly likely to omit some areas of a realistic space because surfaces of some objects are misrecognized as wall surfaces during generation of the initial map. Accordingly, the server 100 according to an embodiment of the present disclosure may expand the generation required areas to reflect a structure of the realistic space as accurately as possible.

The server 100 may determine borders by performing contour approximation on the first spatial map 910, and as a result, a second spatial map 920 may be generated. According to an embodiment of the present disclosure, the server 100 may perform the contour approximation by surrounding an area such that an interior angle of a portion where a border is bent becomes a preset angle (e.g., 90° or 270°). Borders are displayed in the second spatial map 920, and empty areas (areas to which actual images are not attached and which are not indicated by hatching) exist inside the borders. There is a high possibility that objects exist in the empty areas. Accordingly, the server 100 may expand the generation required areas to include even the empty areas.

A result of expanding the generation required areas in the second spatial map 920 is illustrated in a third spatial map 930. Referring to the third spatial map 930, among areas inside the borders, all areas except for areas to which the actual images are attached, are determined as the generation required areas.

When the generation required areas are determined, the server 100 may generate a prompt for generating an image by using a generative model. According to an embodiment of the present disclosure, the server 100 may generate the prompt by using metadata for a target space and metadata for objects (objects included in the captured image) included in the target space.

According to an embodiment of the present disclosure, the “metadata for the target space” may include information on an area where an image is to be generated (e.g., a type of the area when the target space is divided into a plurality of areas such as a master bedroom, a living room, and the like). The initial map may include the metadata for the target space, or the server 100 may obtain the metadata for the target space by performing semantic segmentation on the initial map. Alternatively, a user may directly input the metadata for the target space. Because there is a difference in an overall atmosphere or layout for each type of area included in a space, the server 100 may generate an actual map 940 closer to a realistic appearance by reflecting the metadata for the target space during generation of the prompt.

According to an embodiment of the present disclosure, the “metadata for objects” may include information on objects (e.g., types of the objects) included in the captured image. The server 100 may obtain the metadata for objects by performing object recognition on the captured image.

FIG. 9 illustrates examples of prompts for performing outpainting on the third spatial map 930. For a master bedroom area of the third spatial map 930, the server 100 may generate a first prompt 931 such as “a layout of a master bedroom with a bed” by using “master bedroom” which is the metadata for the target space and “bed” which is the metadata for objects. Similarly, for a living room area of the third spatial map 930, the server 100 may generate a second prompt 932 such as “a layout of a living room with a sofa, a TV stand, a dining table, and an island table” by using “living room” which is the metadata for the target space and “sofa”, “TV stand”, “dining table”, and “island table” which are the metadata for objects.

When the server 100 inputs the first prompt 931 and the second prompt 932 together with the third spatial map 930 into the generative model, the generative model may output the actual map 940. The generative model may be a neural network model implemented by the processor 120 of the server 100 executing a program stored in the memory 130.

According to an embodiment of the present disclosure, the server 100 may recommend a new home appliance or furniture to the user by generating the actual map 940 to include an object (e.g., a home appliance or furniture) that does not exist in the realistic space.

For example, when the user inputs information on a home appliance or furniture to be additionally placed in the target space through the mobile terminal 300, the server 100 may generate a prompt by reflecting the information input by the user. When the user inputs through the mobile terminal 300 that the user wants to additionally arrange an air purifier in the master bedroom, the server 100 may generate a prompt such as “a layout of a master bedroom with an air purifier next to a bed”. As such, the server 100 may generate a prompt to recommend a most suitable position (e.g., next to a bed) for an object to be additionally placed (e.g., an air purifier).

Alternatively, for example, when the user inputs a request to recommend a home appliance or furniture that may be additionally placed in the target space through the mobile terminal 300, the server 100 may determine an object suitable for each area of the space and may generate a prompt to include the determined object. When the user inputs a request to recommend a home appliance or furniture that may be additionally placed in the living room through the mobile terminal 300, the server 100 may decide to add an audio device to the living room and may generate a prompt such as “a layout of a living room with an audio device next to a TV stand”. As such, the server 100 may determine an object (e.g., an audio device) to be added to a specific area (e.g., a living room) of the space, may determine a suitable position (e.g., next to a TV stand) for the determined object to be placed, and then may generate a prompt to recommend the object and the position.

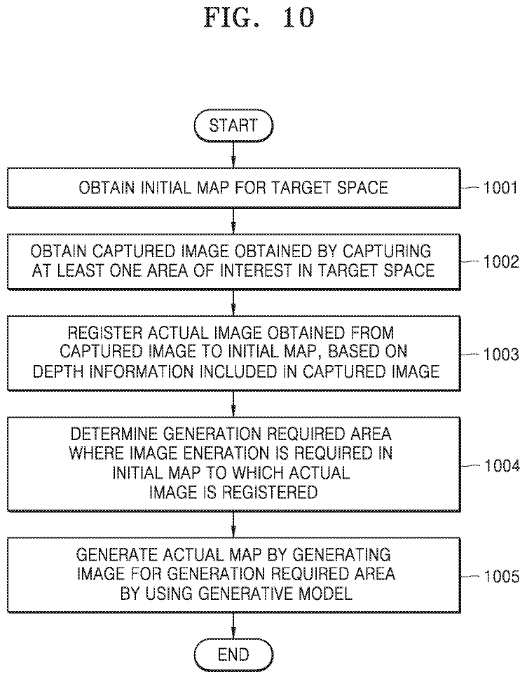

Hereinafter, a method of generating a spatial map according to embodiments of the present disclosure will be described with reference to flowcharts of FIGS. 10 to 18. Because operations included in the flowcharts of FIGS. 10 to 18 are performed by at least one of the server 100, the robot cleaner 200, or the mobile terminal 300 of FIG. 1, the descriptions provided with reference to FIGS. 1 to 9 may apply to FIGS. 10 to 18 even when omitted below.

Hereinafter, it is described that all of the operations included in the flowcharts of FIGS. 10 to 18 are performed by the server 100, but some or all of the operations may be performed by the robot cleaner 200 or the mobile terminal 300.

Referring to FIG. 10, in operation 1001, the server 100 may obtain an initial map for a target space. According to an embodiment of the present disclosure, the server 100 may generate the initial map based on LiDAR scan data received from the robot cleaner 200. Alternatively, the server 100 may receive the initial map from the robot cleaner 200.

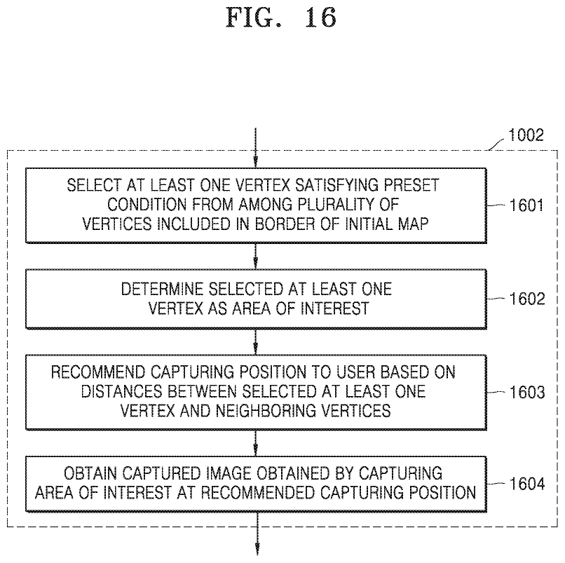

In operation 1002, the server 100 may obtain a captured image obtained by capturing one or more areas of interest in the target space. When the server 100 determines an area of interest in the target space and recommends a capturing position and a capturing direction to a user, the user may capture the area of interest by using the mobile terminal 300, and the mobile terminal 300 may transmit the captured image to the server 100. Operation 1002 will be described in detail with reference to FIG. 16.

FIG. 16 is a flowchart illustrating detailed operations included in operation 1002 of FIG. 10. Referring to FIG. 16, in operation 1601, the server 100 may select at least one vertex satisfying a preset condition from among a plurality of vertices included in a border of the initial map. For example, the server 100 may select a concave vertex (e.g., a vertex having an interior angle of 180° or more) among the vertices included in the border of the initial map.

In operation 1602, the server 100 may determine the selected at least one vertex as the area of interest.

In operation 1603, the server 100 may recommend the capturing position and the capturing direction to the user based on distances between the selected at least one vertex and neighboring vertices. The server 100 may recommend the capturing position and the capturing direction to the user according to the method described above with reference to FIG. 6. The server 100 may recommend the capturing position and the capturing direction to the user in various ways, and according to an embodiment of the present disclosure, the server 100 may display an icon indicating the capturing position and the capturing direction on the initial map displayed on a screen of the mobile terminal 300.

In operation 1604, the server 100 may obtain the captured image obtained by capturing the area of interest at the recommended capturing position. When the user identifies the recommended capturing position and capturing direction through the mobile terminal 300 and captures the area of interest accordingly, the mobile terminal 300 may transmit the captured image to the server 100.

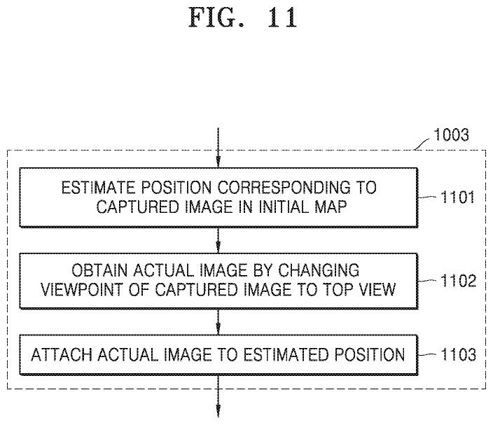

Referring back to FIG. 10, in operation 1003, the server 100 may register an actual image obtained from the captured image to the initial map based on depth information included in the captured image. Detailed operations included in operation 1003 will be described in detail with reference to FIGS. 11 to 15.

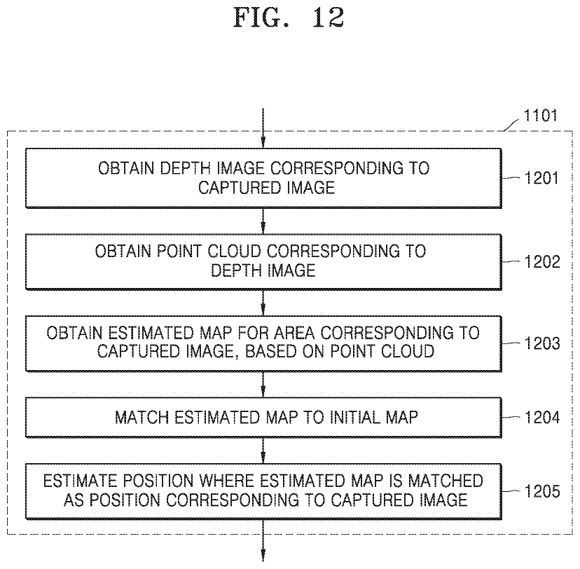

FIG. 11 is a flowchart illustrating detailed operations included in operation 1003 of FIG. 10. Referring to FIG. 11, in operation 1101, the server 100 may estimate a position corresponding to the captured image in the initial map. In other words, the server 100 may determine a position where the captured image is accurately matched in the initial map. Because the user captures the area of interest according to the position and direction recommended by the server 100, the server 100 may roughly know to which position on the initial map the captured image corresponds. However, in order for the server 100 to attach the actual image obtained from the captured image to the initial map, it is necessary to identify an accurate position corresponding to the captured image (or the actual image). A method by which the server 100 obtains the accurate position corresponding to the captured image will be described in detail with reference to FIG. 12.

FIG. 12 is a flowchart illustrating detailed operations included in operation 1101 of FIG. 11. Referring to FIG. 12, in operation 1201, the server 100 may obtain a depth image corresponding to the captured image. The server 100 may obtain the depth image by performing depth estimation on the captured image.

In operation 1202, the server 100 may obtain a point cloud corresponding to the depth image. The server 100 may generate the point cloud by using depth information included in the depth image.

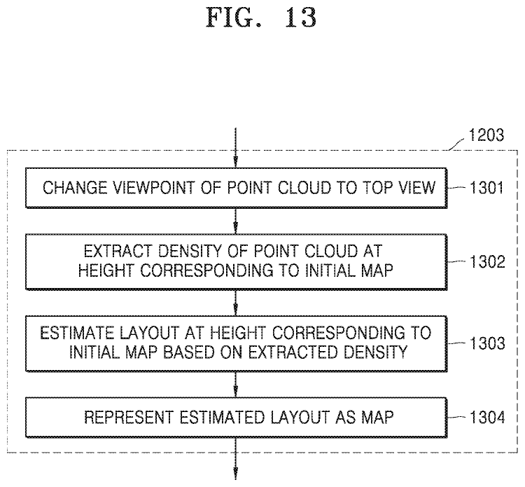

In operation 1203, the server 100 may obtain an estimated map for an area corresponding to the captured image based on the point cloud. The estimated map may represent a layout for the area corresponding to the captured image, and in particular, may represent a layout seen at a height corresponding to the initial map. A specific method of obtaining the estimated map will be described in detail with reference to FIG. 13.

FIG. 13 is a flowchart illustrating detailed operations included in operation 1203 of FIG. 12. Referring to FIG. 13, in operation 1301, the server 100 may change a viewpoint of the point cloud to a top view.

In operation 1302, the server 100 may extract a density of the point cloud at the height corresponding to the initial map. As described above, the “height corresponding to the initial map” may refer to a height at which 1 D scan data (LiDAR scan data) is collected from the target space to generate the initial map. The density extracted by the server 100 from the point cloud may correspond to a density on a cross-section at the height corresponding to the initial map. In other words, the density extracted by the server 100 from the point cloud may correspond to a density of voxels located at the height corresponding to the initial map.

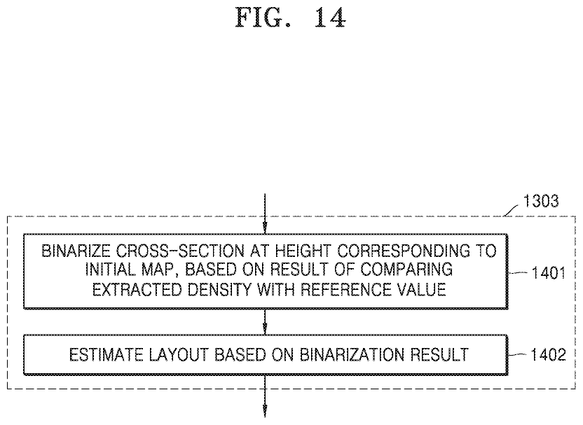

In operation 1303, the server 100 may estimate a layout at the height corresponding to the initial map based on the extracted density. A specific method of estimating the layout will be described in detail with reference to FIG. 14.

FIG. 14 is a flowchart illustrating detailed operations included in operation 1303 of FIG. 13. Referring to FIG. 14, in operation 1401, the server 100 may binarize the cross-section at the height corresponding to the initial map based on a result of comparing the density extracted from the point cloud with a reference value. According to an embodiment of the present disclosure, the server 100 may perform binarization by assigning 1 to voxels whose extracted density is less than the reference value and assigning 0 to voxels whose extracted density is equal to or greater than the reference value. In this case, the reference value may be set to an appropriate value such that a binarization result may most closely represent a layout of a realistic space.

In operation 1402, the server 100 may estimate the layout based on the binarization result.

Referring back to FIG. 13, in operation 1304, the server 100 may obtain the estimated map by representing the estimated layout as a map. According to the embodiment of the present disclosure, the server 100 may generate the estimated map by displaying voxels to which 1 is assigned in white and voxels to which 0 is assigned in black.

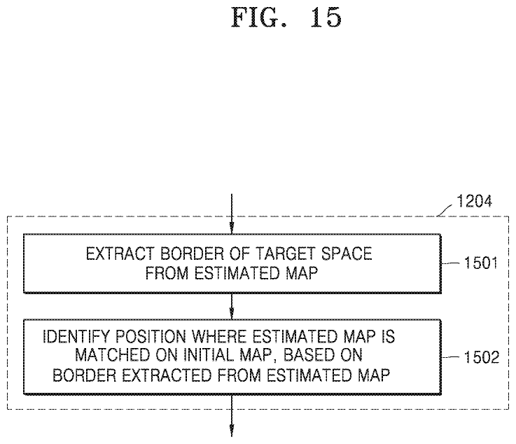

Referring back to FIG. 12, in operation 1204, the server 100 may match the estimated map to the initial map. According to the embodiment of the present disclosure, the server 100 may match the estimated map to the initial map based on a border of the target space identified from the estimated map. A specific method by which the server 100 matches the estimated map to the initial map will be described in detail with reference to FIG. 15.

FIG. 15 is a flowchart illustrating detailed operations included in operation 1204 of FIG. 12. Referring to FIG. 15, in operation 1501, the server 100 may extract the border of the target space from the estimated map. For example, the server 100 may extract the border between a wall surface and a floor from the estimated map.

In operation 1502, the server 100 may identify a position where the estimated map is matched on the initial map based on the border extracted from the estimated map. According to the embodiment of the present disclosure, the server 100 may extract a border from the area of interest of the initial map (area of interest corresponding to the estimated map). The server 100 may identify the position where the estimated map is matched on the initial map by comparing the border extracted from the estimated map with the border extracted from the initial map.

Referring back to FIG. 12, in operation 1205, the server 100 may estimate the position where the estimated map is matched as the position corresponding to the captured image.

Returning back to FIG. 11, in operation 1102, the server 100 may obtain the actual image by changing the viewpoint of the captured image to the top view. According to an embodiment of the present disclosure, the server 100 may obtain a point cloud from the captured image, change a viewpoint of the point cloud to the top view, and then obtain the actual image from the point cloud whose view point is changed.

Information on RGB values corresponding to each position (e.g., a position represented by xyz coordinates) in the space may be stored in the point cloud. For example, when the captured image is an RGB image, the captured image may include pixels to which RGB values are assigned, and RGB values may be assigned to voxels constituting the point cloud based on the RGB values assigned to the pixels of the captured image.

Accordingly, the server 100 may generate the actual image based on the RGB values assigned to the voxels of the point cloud whose viewpoint is changed to the top view.

In operation 1103, the server 100 may attach the actual image to the estimated position. Specifically, the server 100 may attach the actual image (actual image representing the top view layout) obtained from the captured image to the position estimated to correspond to the captured image on the initial map.

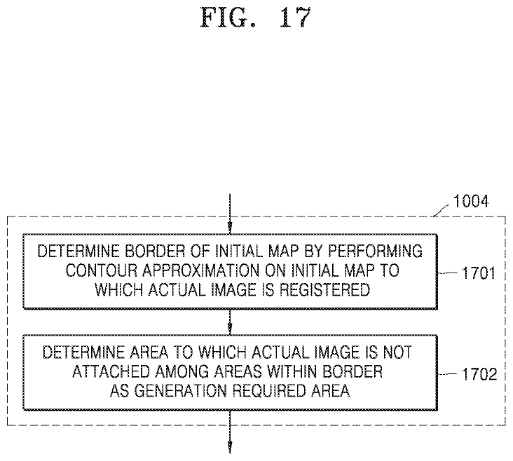

Referring back to FIG. 10, in operation 1004, the server 100 may determine a generation required area where image generation is required in the initial map to which the actual image is registered. In this case, the “generation required area” may refer to an area where an image should be generated by using a generative model. A specific method by which the server 100 determines the generation required area in the initial map will be described in detail with reference to FIG. 17.

FIG. 17 is a flowchart illustrating detailed operations included in operation 1004 of FIG. 10. Referring to FIG. 17, in operation 1701, the server 100 may determine the border of the initial map by performing contour approximation on the initial map to which the actual image is registered. According to an embodiment of the present disclosure, the server 100 may perform the contour approximation by surrounding an area such that an interior angle of a portion where a border is bent becomes a preset angle (e.g., 90° or 270°).

In operation 1702, the server 100 may determine an area to which the actual image is not attached among areas within the border of the initial map as the generation required area. As described above, the spatial map is highly likely to omit some areas of the realistic space because surfaces of some objects are misrecognized as wall surfaces during generation of the initial map. Accordingly, the server 100 may reflect the structure of the realistic space as accurately as possible by expanding the generation required area to all areas to which the actual image is not attached among the areas within the border of the initial map.

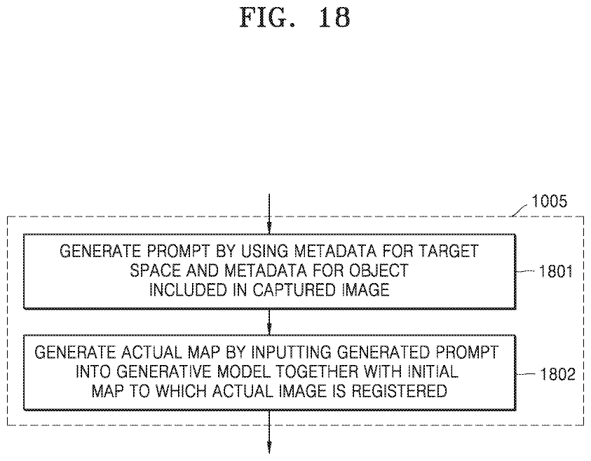

Referring back to FIG. 10, in operation 1005, the server 100 may generate an actual map by generating an image for the generation required area by using the generative model. The server 100 may generate a prompt by using information on the space and objects, and may generate an image by inputting the generated prompt into the generative model, which will be described in detail with reference to FIG. 18.

FIG. 18 is a flowchart illustrating detailed operations included in operation 1005 of FIG. 10. Referring to FIG. 18, in operation 1801, the server 100 may generate the prompt by using metadata for the target space and metadata for an object included in the captured image. A method by which the server 100 generates the prompt by using metadata for the target space and the object is the same as described above with reference to FIG. 9. In addition, as described above, according to an embodiment of the present disclosure, the server 100 may recommend a layout of a new home appliance or furniture to the user by generating the prompt to include information on an object (e.g., a home appliance or furniture) that does not exist in the realistic space.

In operation 1802, the server 100 may generate the actual map by inputting the generated prompt into the generative model together with the initial map to which the actual image is registered.

According to the above-described embodiments, an effect of improving user experience may be expected by providing the user with a spatial map (actual map) represented similarly to an appearance of the realistic space.

According to an embodiment of the disclosure, there is provided a method including: obtaining an initial map of a target space; obtaining a captured image of at least one area of interest in the target space; registering, based on depth information included in the captured image, an actual image to the initial map, the actual image being obtained from the captured image; determining a generation required area for which image generation is required in the initial map to which the actual image is registered; and generating, by using a generative model, an actual map by generating an image for the generation required area.

The registering to the initial map may include: obtaining an estimated position corresponding to the captured image in the initial map; obtaining the actual image by changing a viewpoint of the captured image to a top view; and attaching the actual image to the estimated position.

The obtaining the estimated position corresponding to the captured image may include: obtaining a depth image corresponding to the captured image; obtaining a point cloud corresponding to the depth image; obtaining, based on the point cloud, an estimated map for an area corresponding to the captured image; matching the estimated map to the initial map; and estimating a position where the estimated map is matched as the estimated position corresponding to the captured image.

The obtaining the estimated map may include: changing a viewpoint of the point cloud to the top view; extracting a density of the point cloud at a height corresponding to the initial map; obtaining an estimated layout at the height corresponding to the initial map based on the density; and representing the estimated layout as a map.

The obtaining the estimated layout may include: binarizing, based on a result of comparing the density with a preset reference value, a cross-section at the height corresponding to the initial map; and obtaining the estimated layout based on a result of the binarizing.

The obtaining of the captured image may include: selecting at least one vertex satisfying a preset condition from among a plurality of vertices included in a border of the initial map; determining the at least one vertex as the at least one area of interest; providing a recommended capturing position to a user based on distances between the at least one vertex and neighboring vertices; and obtaining the captured image by capturing the at least one area of interest at the recommended capturing position.

The determining the generation required area may include: determining the border of the initial map by performing contour approximation on the initial map to which the actual image is registered; and determining an area, to which the actual image is not attached among areas within the border, as the generation required area.

The generating the actual map may include: generating a prompt by using metadata for the target space and metadata for an object included in the captured image; and generating the actual map by inputting the prompt into the generative model together with the initial map to which the actual image is registered.

According to an embodiment of the disclosure, there is provided a non-transitory computer-readable recording medium having recorded thereon a program including instructions that, when executed by at least one processor of an electronic device, may cause the electronic device to perform a method including: obtaining an initial map of a target space; obtaining a captured image of at least one area of interest in the target space; based on depth information included in the captured image, registering an actual image to the initial map, the actual image being obtained from the captured image; determining a generation required area for which image generation is required in the initial map to which the actual image is registered; and generating, by using a generative model, an actual map by generating an image for the generation required area.

According to an embodiment of the disclosure, there is provided an electronic device for generating a spatial map, the electronic device including: memory storing instructions; and at least one processor, wherein the instructions, when executed by the at least one processor individually or collectively, may cause the electronic device to: obtain an initial map for a target space, obtain a captured image of at least one area of interest in the target space, register, based on depth information included in the captured image, an actual image to the initial map, the actual image being obtained from the captured image, determine a generation required area for which image generation is required in the initial map to which the actual image is registered, and generate, by using a generative model, an actual map by generating an image for the generation required area.

The instructions, when executed by the at least one processor individually or collectively, may cause the electronic device to the actual image to the initial map by: obtaining an estimated position corresponding to the captured image in the initial map, obtaining the actual image by changing a viewpoint of the captured image to a top view, and attaching the actual image to the estimated position.

The instructions, when executed by the at least one processor individually or collectively, may cause the electronic device to obtain the estimated position corresponding to the captured image by: obtaining a depth image corresponding to the captured image, obtaining a point cloud corresponding to the depth image, obtaining, based on the point cloud, an estimated map for an area corresponding to the captured image, matching the estimated map to the initial map, and estimating a position where the estimated map is matched as the estimated position corresponding to the captured image.

The instructions, when executed by the at least one processor individually or collectively, may cause the electronic device to obtain the estimated map by: changing a viewpoint of the point cloud to the top view, extracting a density of the point cloud at a height corresponding to the initial map, obtaining an estimated layout at the height corresponding to the initial map based on the density, and representing the estimated layout as a map.

The instructions, when executed by the at least one processor individually or collectively, may cause the electronic device obtain the estimated layout by: binarize, based on a result of comparing the density with a preset reference value, a cross-section at the height corresponding to the initial map, and obtain the estimated layout based on a result of the binarizing.

The instructions, when executed by the at least one processor individually or collectively, may cause the electronic device to obtain the captured image by: select at least one vertex satisfying a preset condition from among a plurality of vertices included in a border of the initial map, determine the at least one vertex as the at least one area of interest, providing a recommended capturing position to a user based on distances between the at least one vertex and neighboring vertices, and obtain the captured image by capturing the at least one area of interest at the recommended capturing position.

The instructions, when executed by the at least one processor individually or collectively, may cause the electronic device to determine the generation required area by: determining the border of the initial map by performing contour approximation on the initial map to which the actual image is registered; and determining an area, to which the actual image is not attached among areas within the border, as the generation required area.

The instructions, when executed by the at least one processor individually or collectively, may cause the electronic device to generate the actual map by: generating a prompt by using metadata for the target space and metadata for an object included in the captured image; and generating the actual map by inputting the prompt into the generative model together with the initial map to which the actual image is registered.

Various embodiments of the present disclosure may be implemented or supported by one or more computer programs, each of which is formed from computer-readable program code and embodied in a computer-readable medium. The terms “application” and “program” used herein refer to one or more computer programs, software components, sets of instructions, procedures, functions, objects, classes, instances, related data, or a portion thereof adapted for implementation in suitable computer-readable program code. The phrase “computer-readable program code” includes any type of computer code, including source code, object code, and executable code. The phrase “computer-readable medium” may include any type of medium capable of being accessed by a computer, such as read-only memory (ROM), random-access memory (RAM), a hard disk drive (HDD), a compact disc (CD), a digital video disc (DVD), or any other type of memory.

Also, the machine-readable storage medium may be provided as a non-transitory storage medium. The “non-transitory storage medium” is a tangible device, and may exclude wired, wireless, optical, or other communication links that transmit transitory electrical or other signals. In this case, “non-transitory” does not distinguish whether data is semi-permanently or temporarily stored in the storage medium. For example, the “non-transitory storage medium” may include a buffer in which data is temporarily stored. The computer-readable medium may be any available medium that may be accessed by a computer and may include both volatile and non-volatile media, and removable and non-removable media. The computer-readable medium includes media where data may be permanently stored and media where data may be stored and later overwritten, such as a rewritable optical disc or an erasable memory device.

According to an embodiment, a method according to various embodiments disclosed herein may be included and provided in a computer program product. The computer program product may be traded between a seller and a buyer as a product. The computer program product may be distributed in a form of machine-readable storage medium (e.g., a CD-ROM), or distributed (e.g., downloaded or uploaded) through an application store or directly or online between two user devices (e.g., smart phones). In the case of online distribution, at least a portion of the computer program product (e.g., a downloadable app) may be at least temporarily stored in a machine-readable storage medium such as a memory of a manufacturer's server, a server of an application store, or a relay server, or may be temporarily generated.

The above description of the present disclosure is provided for illustration, and it will be understood by one of ordinary skill in the art that various changes in form and details may be readily made therein without departing from essential features and the scope of the present disclosure as defined by the following claims. For example, appropriate results may be achieved even when the described techniques are performed in a different order from the described method, and/or the described elements such as a system, a structure, an apparatus, and a circuit are combined or integrated in a different manner from the described method or replaced or substituted by other elements or equivalents. Accordingly, the above embodiments are examples only in all aspects and embodiments of the disclosure are not limited thereto. For example, each component described as a single type may implemented in a distributed manner, and similarly, components described as being distributed may also be implemented in a combined form.

The scope of the present disclosure is defined by the appended claims rather than the detailed description, and all changes or modifications within the scope of the appended claims and their equivalents will be construed as being included in the scope of the present disclosure.

What is claimed is:

1. A method comprising:
obtaining an initial map of a target space;
obtaining a captured image of at least one area of interest in the target space;
registering, based on depth information included in the captured image, an actual image to the initial map, the actual image being obtained from the captured image;
determining a generation required area for which image generation is required in the initial map to which the actual image is registered; and
generating, by using a generative model, an actual map by generating an image for the generation required area.

2. The method of claim 1, wherein the registering to the initial map comprises:
obtaining an estimated position corresponding to the captured image in the initial map;
obtaining the actual image by changing a viewpoint of the captured image to a top view; and
attaching the actual image to the estimated position.

3. The method of claim 2, wherein the obtaining the estimated position corresponding to the captured image comprises:
obtaining a depth image corresponding to the captured image;
obtaining a point cloud corresponding to the depth image;
obtaining, based on the point cloud, an estimated map for an area corresponding to the captured image;
matching the estimated map to the initial map; and
estimating a position where the estimated map is matched as the estimated position corresponding to the captured image.

4. The method of claim 3, wherein the obtaining the estimated map comprises:
changing a viewpoint of the point cloud to the top view;
extracting a density of the point cloud at a height corresponding to the initial map;
obtaining an estimated layout at the height corresponding to the initial map based on the density; and
representing the estimated layout as a map.

5. The method of claim 4, wherein the obtaining the estimated layout comprises:
binarizing, based on a result of comparing the density with a preset reference value, a cross-section at the height corresponding to the initial map; and
obtaining the estimated layout based on a result of the binarizing.

6. The method of claim 1, wherein the obtaining of the captured image comprises:
selecting at least one vertex satisfying a preset condition from among a plurality of vertices included in a border of the initial map;
determining the at least one vertex as the at least one area of interest;
providing a recommended capturing position to a user based on distances between the at least one vertex and neighboring vertices; and
obtaining the captured image by capturing the at least one area of interest at the recommended capturing position.

7. The method of claim 1, wherein the determining the generation required area comprises:
determining the border of the initial map by performing contour approximation on the initial map to which the actual image is registered; and
determining an area, to which the actual image is not attached among areas within the border, as the generation required area.

8. The method of claim 1, wherein the generating the actual map comprises:
generating a prompt by using metadata for the target space and metadata for an object included in the captured image; and
generating the actual map by inputting the prompt into the generative model together with the initial map to which the actual image is registered.

9. A non-transitory computer-readable recording medium having recorded thereon a program including instructions that, when executed by at least one processor of an electronic device, cause the electronic device to perform a method comprising:
obtaining an initial map of a target space;
obtaining a captured image of at least one area of interest in the target space;
based on depth information included in the captured image, registering an actual image to the initial map, the actual image being obtained from the captured image;
determining a generation required area for which image generation is required in the initial map to which the actual image is registered; and
generating, by using a generative model, an actual map by generating an image for the generation required area.

10. An electronic device for generating a spatial map, the electronic device comprising:
memory storing instructions; and
at least one processor,
wherein the instructions, when executed by the at least one processor individually or collectively, cause the electronic device to:
obtain an initial map for a target space,
obtain a captured image of at least one area of interest in the target space,
register, based on depth information included in the captured image, an actual image to the initial map, the actual image being obtained from the captured image,
determine a generation required area for which image generation is required in the initial map to which the actual image is registered, and
generate, by using a generative model, an actual map by generating an image for the generation required area.

11. The electronic device of claim 10, wherein the instructions, when executed by the at least one processor individually or collectively, cause the electronic device to register the actual image to the initial map by:
obtaining an estimated position corresponding to the captured image in the initial map,
obtaining the actual image by changing a viewpoint of the captured image to a top view, and
attaching the actual image to the estimated position.

12. The electronic device of claim 11, wherein the instructions, when executed by the at least one processor individually or collectively, cause the electronic device to obtain the estimated position corresponding to the captured image by:
obtaining a depth image corresponding to the captured image,
obtaining a point cloud corresponding to the depth image,
obtaining, based on the point cloud, an estimated map for an area corresponding to the captured image,
matching the estimated map to the initial map, and
estimating a position where the estimated map is matched as the estimated position corresponding to the captured image.

13. The electronic device of claim 12, wherein the instructions, when executed by the at least one processor individually or collectively, cause the electronic device to obtain the estimated map by:
changing a viewpoint of the point cloud to the top view,
extracting a density of the point cloud at a height corresponding to the initial map,
obtaining an estimated layout at the height corresponding to the initial map based on the density, and
representing the estimated layout as a map.

14. The electronic device of claim 13, wherein the instructions, when executed by the at least one processor individually or collectively, cause the electronic device to obtain the estimated layout by:
binarize, based on a result of comparing the density with a preset reference value, a cross-section at the height corresponding to the initial map, and
obtain the estimated layout based on a result of the binarizing.

15. The electronic device of claim 10, wherein the instructions, when executed by the at least one processor individually or collectively, cause the electronic device to obtain the captured image by:
select at least one vertex satisfying a preset condition from among a plurality of vertices included in a border of the initial map,
determine the at least one vertex as the at least one area of interest,
providing a recommended capturing position to a user based on distances between the at least one vertex and neighboring vertices, and
obtain the captured image by capturing the at least one area of interest at the recommended capturing position.

16. The electronic device of claim 15, wherein the instructions, when executed by the at least one processor individually or collectively, cause the electronic device to determine the generation required area by:
determining the border of the initial map by performing contour approximation on the initial map to which the actual image is registered; and
determining an area, to which the actual image is not attached among areas within the border, as the generation required area.

17. The electronic device of claim 10, wherein the instructions, when executed by the at least one processor individually or collectively, cause the electronic device to generate the actual map by:
generating a prompt by using metadata for the target space and metadata for an object included in the captured image; and
generating the actual map by inputting the prompt into the generative model together with the initial map to which the actual image is registered.
